(19) United States
(12) Patent Application Publication
(10) Pub. No.: US 2025/0222940 A1
(43) Pub. Date: Jul. 10, 2025

(54) METHOD AND DEVICE OF DETERMINING TRAVELING STABILITY RISK FACTOR BY DETECTING PART OF ROAD WHEEL ACTUATOR

(71) Applicant: HL MANDO CORPORATION, Pyeongtaek (KR)

(72) Inventors: Hansang CHAE, Pyeongtaek (KR); Sunggun LEE, Pyeongtaek (KR); Jaewoo LEE, Pyeongtaek (KR)

(21) Appl. No.: 18/655,230

(22) Filed: May 4, 2024

(30) Foreign Application Priority Data
Jan. 10, 2024 (KR) 10-2024-0003927

(51) Int. Cl. B60W 50/02; B60W 50/00; B62D 5/00; B62D 15/02

(52) U.S. Cl. CPC B60W 50/0205; B60W 50/0098; B62D 5/006; B62D 15/021; B60W 2050/0083; B60W 2520/28; B60W 2540/18

(57) ABSTRACT

A method which is performed by a steering device control device and determines a traveling stability risk factor by detecting a part of a road wheel actuator is provided. The method includes (a) transmitting a steering angle of a driver from a steering wheel actuator to a road wheel actuator, (b) transmitting a feedback torque from the road wheel actuator to the driver based on a rack force, determining micro-buckling of a tie-rod during the (a) and (b), and when the micro-buckling is determined, providing the determination to a traveling vehicle system.

### TECHNICAL FIELD

The present invention relates to a method and device of determining a traveling stability risk factor by detecting a part of a road wheel actuator, and more specifically, the present invention relates to a method and device for determining a risk factor for traveling safety of a traveling vehicle by determining tie-rod buckling according to a compensation amount in addition to determining straightness according to the compensation amount.

### BACKGROUND

Unlike general-purpose steering devices, a Steer By Wire (SbW) includes a Steer wheel Feedback Actuator (SFA) and a Road Wheel Actuator (RWA). Since the two systems are not mechanically connected, a driver cannot easily sense abnormalities in the RWA mechanism. For example, even when a tie rod buckles due to a large external force outside a wheel, the driver may not feel the buckling, but a Toe value of the wheel may change, and thus, a vehicle may not move straightly.

Depending on the status of the RWA and SFA, even though the driver is traveling straight, a certain level of bias may occur in the RWA depending on the condition and slope of the road surface. However, bias that exceeds a range that can normally occur may be sensed since it is considered that the buckling occurs in the RWA.

In the event of a curb collision or large impact outside the wheel, the RWA device is designed to cause buckling at the thinnest portion of the tie-rod to protect the reducer unit, which can be confirmed from the exterior. However, when micro-buckling occurs to the extent that it is not clearly visible to the naked eye, problems may occur as the vehicle may be driven in a broken state.

When micro-buckling occurs, toe-in or toe-out occurs only on one side of the tire, making it impossible to drive straight, and a problem arises where the vehicle cannot go straight and the driver must continuously correct the steering to make the vehicle go straight. Moreover, even when the vehicle moves straight, excessive toe may cause tire wear and cause understeer and oversteer, making the behavior of the vehicle unstable. Therefore, there is a need to discuss a determination logic that can solve these problems and determine the traveling safety of a traveling vehicle.

The above-mentioned background technology is technical information that the inventor possessed to derive the present disclosure or is acquired in the process of deriving the present disclosure, and cannot necessarily be said to be technology known to the general public prior to the filing of the present disclosure.

### SUMMARY

The present invention is to provide a method capable of determining that bias is generated by buckling and detecting the bias, when bias occurring in RWA exceeds a range that normally occurs according to conditions and slope of a road surface even though the driver is driving straight depending on the states of the RWA and SFA.

In addition, the present invention a method of compensating for the generated bias to enable the vehicle to proceed straight or to transmit an abnormality through notification to the driver.

According to an aspect the present disclosure, there is provided a method which is performed by a steering device control device and determines a traveling stability risk factor by detecting a part of a road wheel actuator, the method including: (a) transmitting a steering angle of a driver from a steering wheel actuator to a road wheel actuator; (b) transmitting a feedback torque from the road wheel actuator to the driver based on a rack force; determining micro-buckling of a tie-rod during the (a) and (b); and when the micro-buckling is determined, providing the determination to a traveling vehicle system.

In one embodiment, the determining of the micro-buckling of the tie-rod may further include checking a wheel speed, a rack speed, and a vehicle rotation angle speed.

In one embodiment, the determining of the micro-buckling of the tie-rod may further include checking a rack target position, a rack position location, and the rack force.

In one embodiment, the determining of the micro-buckling of the tie-rod may further include setting a compensation amount in a straight-forward determination logic.

In one embodiment, when the micro-buckling is determined, providing of the determination to the traveling vehicle system may further include calculating information about a traveling vehicle.

In one embodiment, when the micro-buckling is determined, the providing of the determination to the traveling vehicle system may further include checking a system allowable maximum compensation amount based on the information about the traveling vehicle.

In one embodiment, when the micro-buckling is determined, the providing of the determination to the traveling vehicle system may further include setting the information provided to the traveling vehicle according to the system allowable maximum compensation amount.

According to the present invention, it is possible to determine that bias is generated by buckling and detecting the bias, when bias occurring in RWA exceeds a range that normally occurs according to conditions and slope of a road surface even though the driver is driving straight depending on the states of the RWA and SFA.

In addition, according to the present invention, it is possible compensate for the generated bias to enable the vehicle to proceed straight or to transmit an abnormality through notification to the driver.

### BRIEF DESCRIPTION OF THE DRAWINGS

FIG. 1 illustrates an example environment in which a steering device control device according to some embodiments of the present disclosure may be applied.

FIG. 2 is an example block diagram for explaining a steering device according to some embodiments of the present disclosure.

FIG. 3 is a flowchart of an operation for determining micro-buckling that can be performed in the steering device control device according to some embodiments of the present disclosure.

FIG. 4 is a flowchart for a detailed explanation of steps for determining micro-buckling of a tie-rod according to some embodiments of the present disclosure.

FIG. 5 is a flowchart for a detailed explanation of steps provided to a traveling vehicle when determining micro-buckling according to some embodiments of the present disclosure.

FIG. 6 is a diagram of an example computing device that may implement devices and/or systems according to various embodiments of the present disclosure.

### DETAILED DESCRIPTION

Hereinafter, preferred embodiments of the present disclosure will be described in detail with reference to the attached drawings. The advantages and features of the present disclosure and methods for achieving them will become clear by referring to the embodiments described in detail below along with the accompanying drawings. However, the technical idea of the present disclosure is not limited to the following embodiments and may be implemented in various different forms, the following examples are provided solely to complete the technical idea of the present disclosure and to completely inform those skilled in the art of the present disclosure of the scope of the disclosure, and a technical idea of the present disclosure is only defined by the scope of the claims.

When adding reference numerals to components in each drawing, it should be noted that the same components are indicated by the same reference numerals as much as possible even when they are illustrated in different drawings. Additionally, in describing the present disclosure, when it is determined that a detailed description of a related known configuration or function may obscure the gist of the present disclosure, detailed descriptions thereof will be omitted.

Unless otherwise defined, all terms (including technical and scientific terms) used in the present specification may be used with meanings that can be commonly understood by those skilled in the art to which the present disclosure pertains. Additionally, terms defined in commonly used dictionaries are not interpreted ideally or excessively unless clearly specifically defined. The terminology used herein is for the purpose of describing embodiments and is not intended to limit the disclosure. In the present specification, singular forms also include plural forms unless specifically stated in the phrase.

Additionally, in describing the components of the present disclosure, terms such as first, second, A, B, (a), and (b) may be used. These terms are only used to distinguish the component from other components, and the nature, sequence, or order of the component is not limited by the term. When a component is described as being “connected,” “coupled,” or “joined” to another component, that component may be directly connected or joined to the other component, but it should be understood that another component may be “connected,” “coupled,” or “joined” between each component.

As used herein, expressions “comprises” and/or “comprising” mean that referenced components, steps, operations and/or elements do not exclude presence or addition of one or more other components, steps, operations and/or elements.

Hereinafter, various embodiments of the present disclosure will be described in detail with reference to the attached drawings.

Additionally, when describing the components of the present disclosure, terms such as first, second, A, B, (a), and (b) can be used. These terms are only used to distinguish the component from other components, and the nature, sequence, or order of the component is not limited by the term. Throughout the specification, when a part is said to “include” or “have” a certain component, this means that it does not exclude other components but may further include other components, unless specifically stated to the contrary. Additionally, terms such as “unit” and “module” used in the specification refer to a unit that processes at least one function or operation, and may be implemented as hardware, software, or a combination of hardware and software.

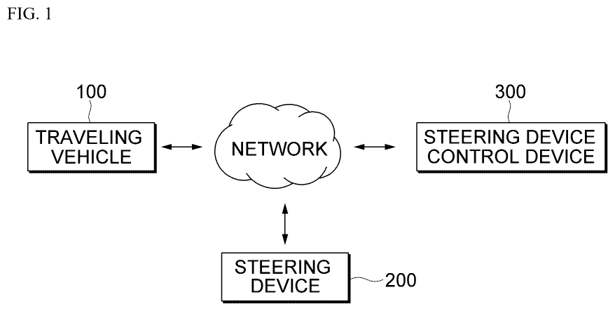

FIG. 1 illustrates an example environment in which a steering control device according to some embodiments of the present disclosure may be applied. An operation is performed to detect buckling of the attached parts of a road wheel actuator through a system including a traveling vehicle 100, a steering device 200, and a steering device control device 300 illustrated in FIG. 1, and through this, traveling safety of the traveling vehicle 100 can be determined.

Hereinafter, the operations of the components illustrated in FIG. 1 related to determining the traveling safety of the traveling vehicle 100 through the above-described system will be described in more detail.

FIG. 1 illustrates an example where the traveling vehicle 100, the steering device 200, and the steering device control device 300 are connected through a network, but this is only for convenience of understanding, and the number of devices that can be connected to the network can vary.

Meanwhile, FIG. 1 only illustrates a preferred embodiment for achieving the purpose of the present disclosure, and some components may be added or deleted as needed. Hereinafter, the components illustrated in FIG. 1 will be described in more detail.

The steering device control device 300 can collect and analyze various information generated from the traveling vehicle 100. The various information may include all data generated from the traveling vehicle 100, for example, a speed of the traveling vehicle, a wheel angle of a steering device, the specifications of the traveling vehicle itself, or the like, and further, may include information about an environment in which the traveling vehicle is traveling. This information may be information collected using a series of devices within the traveling vehicle 100 while the traveling vehicle 100 is traveling, and from the perspective of a person skilled in the art, it is obvious that the series of devices may include all electronic devices included in the traveling vehicle 100. Additionally, this information may include information collected when the vehicle is stopped rather than traveling.

The traveling vehicle 100 illustrated in FIG. 1 may include not only a vehicle equipped with autonomous driving technology, but also a vehicle that is not equipped with general autonomous driving technology. The traveling vehicle 100 may include both a four-wheeled vehicle and a two-wheeled motorcycle.

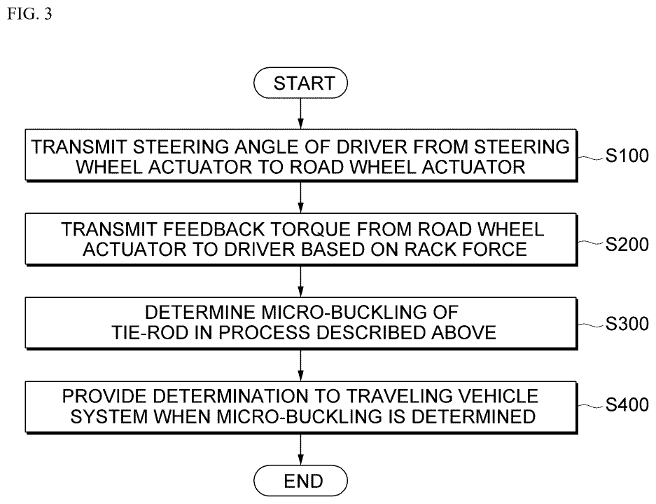

In order to avoid redundant description, various operations performed by the steering device control device 300 will be described in more detail later with reference to the drawings of FIG. 3 and below.

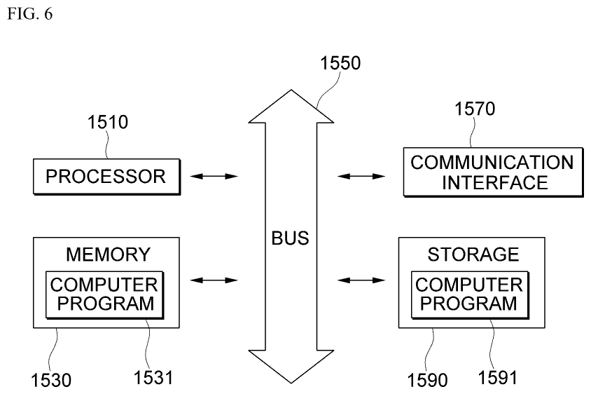

Meanwhile, the steering device control device 300 may be implemented as one or more computing devices. For example, all functions of the steering device control device 300 may be implemented in a single computing device. As another example, a first function of the steering control device 300 may be implemented in a first computing device, and a second function may be implemented in a second computing device. Here, the computing device may be a notebook, a desktop, a laptop, or the like., but is not limited thereto and may include all types of devices equipped with a computing function. However, it may be desirable for the steering device control device 300 to be implemented as a high-performance server-class computing device. An example of the computing device will be described with reference to FIG. 6.

Additionally, functions that can be implemented by the steering device control device 300 may also be implemented using electronic devices mounted on the traveling vehicle 100. Therefore, in FIG. 1, the steering device control device 300 and the traveling vehicle 100 are illustrated separately, but according to one embodiment, it is natural that the steering device control device 300 is mounted on the traveling vehicle 100 so that the corresponding device can implement the first function, the second function, or the like within the traveling vehicle 100. Therefore, it should be noted that the interpretation is not limited to an embodiment in which the traveling vehicle 100 and the steering device control device 300 are externally separated as illustrated in FIG. 1.

In the present specification, for convenience of explanation, a situation in which the traveling vehicle 100 and the steering device control device 300 implement functions separately will be described.

In some embodiments, components included in the environment to which the steering device control device 300 is applied may communicate over a network. The network can be implemented as all types of wired/wireless networks such as Local Area Network (LAN), Wide Area Network (WAN), mobile radio communication network, Wibro (Wireless Broadband Internet), or the like.

Meanwhile, the environment illustrated in FIG. 1 illustrates that the traveling vehicle 100 and the steering device control device 300 are connected through a network, but the scope of the present disclosure is not limited thereto, and it should be noted that the traveling vehicle 100 may be connected to the steering device control device 300 via a Peer to Peer (P2P).

So far, with reference to FIG. 1, an exemplary environment in which the corresponding device 200 according to some embodiments of the present disclosure can be applied has been described. Hereinafter, with reference to the drawings of FIG. 3 and below, methods according to various embodiments of the present disclosure will be described in detail.

Each step of the methods to be described later may be performed by a computing device. In other words, each step of the methods may be implemented with one or more instructions executed by the processor of the computing device. All steps included in these methods may be performed by a single physical computing device, however, the first steps of the method may be performed by a first computing device and the second steps of the method may be performed by a second computing device.

Hereinafter, in FIG. 3, the description will be continued assuming that each step of the methods is performed by the steering device control device 300 illustrated in FIG. 1. However, for convenience of explanation, the description of the operator of each step included in the methods may be omitted.

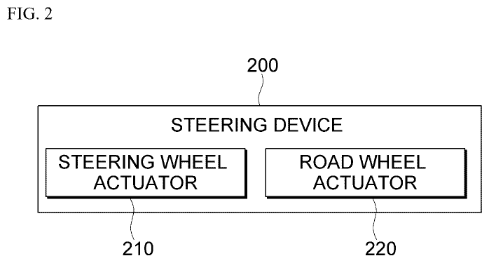

In addition, in FIG. 2 below, the steering device 200 mounted on the traveling vehicle is schematically illustrated to continue the description. The components of the device for correcting the steering of the traveling vehicle 100 are explained through a simplified schematic drawing, but it should be noted that the present disclosure is not intended to primarily describe the technical composition or component composition of the steering device 200 itself.

FIG. 2 is an example block diagram for explaining a steering device according to some embodiments of the present disclosure.

The traveling vehicle 100 may include the steering device 200. It goes without saying that the steering device 200 may include all mechanical devices for steering the traveling direction of the traveling vehicle 100 and all parts that transmit and receive electrical signals.

The steering device 200 may transmit and receive electrical signals with the steering device control device 300.

The steering device 200 may steer the direction of the traveling vehicle 100 according to steering of a driver while the traveling vehicle 100 is traveling, and may steer the driving direction of the traveling vehicle 100 according to a certain algorithm without the intervention of the driver of the traveling vehicle 100 in an autonomous traveling situation without the steering of the driver.

The steering device 200 may be an SBW system or a steering device including the system. Here, the SBW system is Steer-by-Wire, which can refer to an electric signal-type intelligent steering system that transmits and controls the steering intention of the driver through electrical signals without a mechanical connection between the steering wheel of the driver and the vehicle wheels.

According to one example, a steering wheel actuator 210 included in the steering device 200 is a Steering Feedback Actuator, which is an actuator that provides a reaction force to the steering wheel of the driver.

In addition, a road wheel actuator 220 included in the steering device 200 is a road wheel actuator that transmits the steering intention of the driver to the vehicle wheels and moves the wheels.

The steering wheel actuator 210 and the road wheel actuator 220 are not mechanically connected and driven, but are driven by transmitting and receiving electrical signals to each other. Additionally, the steering wheel actuator 210 and the road wheel actuator 220 may each move according to different inputs.

Since the directions of the steering wheel actuator 210 and the road wheel actuator 220 should be matched to each other when the traveling vehicle 100 is traveling at high speed, either the steering wheel actuator 210 or the road wheel actuator 220 becomes the main steering system of the traveling vehicle 100, and the non-main system is controlled with a value matching the output of the main system. More specifically, when one of the steering wheel actuator 210 and the road wheel actuator 220 system is the main system, the main system can subordinately control the non-main system.

When the traveling vehicle 100 is not autonomously driven but is controlled by the steering of the driver, the road wheel actuator 220 may move to reflect the steering intention of the driver.

In this case, since the steering wheel actuator 210 and the road wheel actuator 220 are not mechanically connected and driven, the driver cannot easily feel any abnormalities in the mechanical portions. For example, even when a tie rod buckles due to a large external force outside a wheel, the driver may not feel the buckling, but a Toe value of the wheel may change, and thus, the vehicle may not to drive straight.

Even though the driver is traveling straight depending on the states of the steering wheel actuator 210 and the road wheel actuator 220, a certain level of bias may occur in the road wheel actuator 220 according to conditions and slope of a road surface. In this case, in the bias exceeding a range that normally occurs, it is determined that the buckling is generated from the road wheel actuator 220, and the bias can be detected. The generated bias may be compensated to allow the vehicle to drive straight, or the abnormality may be transmitted to the driver through notification.

In the event of a curb collision or large impact outside the wheel, the road wheel actuator 220 is designed to cause buckling at the thinnest portion of the tie-rod to protect the reducer unit, which can be confirmed from the exterior. However, when micro-buckling occurs to the extent that it is not clearly visible to the naked eye, problems may occur as the vehicle may be driven in a broken state.

When micro-buckling occurs, toe-in or toe-out occurs only on one side of the tire, making it impossible to drive straight, and a problem arises where the vehicle cannot go straight and the driver must continuously correct the steering to make the vehicle go straight. Moreover, even when the vehicle moves straight, excessive toe may cause tire wear and cause understeer and oversteer, making the behavior of the vehicle unstable. Therefore, the present invention relates to determining Tie-Rod buckling according to a compensation amount in addition to straightness determination according to the compensation amount using the existing straight-forward determination logic. Hereinafter, specific operations will be described in detail using FIG. 3.

FIG. 3 is a flowchart of an operation for determining the micro-buckling that can be performed in the steering device control device according to some embodiments of the present disclosure.

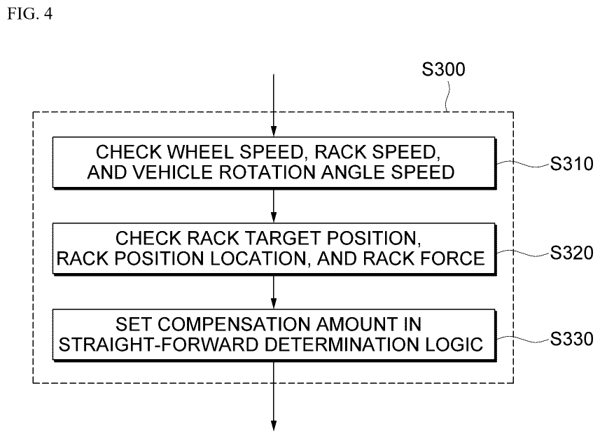

In Step S100, the steering device control device 300 may control to transmit the steering angle of the driver from the steering wheel actuator 210 to the road wheel actuator 220. In Step S200, the steering device control device 300 may control to transmit feedback torque from the road wheel actuator 220 to the driver based on a rack force. In Step S300, the steering device control device 300 may determine the micro-buckling of the tie-rod during Steps S100 and S200. Specific operations related to this will be described in detail with reference to FIG. 4.

FIG. 4 is a flowchart for a detailed explanation of the steps for determining the micro-buckling of the tie-rod according to some embodiments of the present disclosure.

In Step S310, the steering device control device 300 can check a wheel speed, a rack speed, and a vehicle rotation angle speed. The information may be information transmitted and received in real time by the steering device control device 300 in the traveling vehicle 100, and the information may be information acquired over a certain period of time.

In Step S320, the steering device control device 300 can check a rack target position, a rack position location, and a rack force. In this case, the rack force may mean a steering torque for manipulating a steering wheel of a traveling vehicle, a steering rod torque to which the steering torque is applied, and a steering rack force to which the rod torque is applied to the wheels of the vehicle.

The information may be information transmitted and received in real time by the steering device control device 300 in the traveling vehicle 100, and the information may be information acquired over a certain period of time. Based on this information, the steering device control device 300 may set the compensation amount in straight-forward determination logic in Step S330.

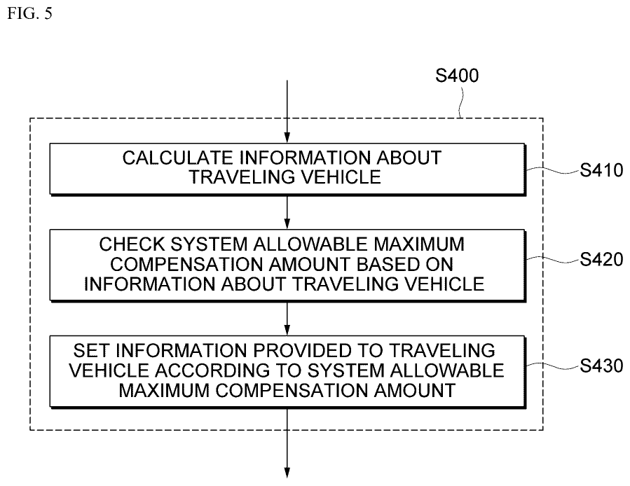

Returning to FIG. 3, in Step S400, when the micro-buckling is determined, the steering device control device 300 may provide the determination to the traveling vehicle 100. In this case, when the micro-buckling is determined, the steering device control device 300 may determine whether to perform compensation with an actual compensation amount, perform compensation with a flag for deviation values equal to or more than the maximum compensation amount, or distinguish compensation by adding a Roll Angle. Hereinafter, specific details will be described in detail with reference to FIG. 5.

FIG. 5 is a flowchart for a detailed explanation of steps provided to the traveling vehicle when determining the micro-buckling according to some embodiments of the present disclosure.

In Step S410, the steering device control device 300 may calculate information about the traveling vehicle 100. In this case, it should be noted that the traveling vehicle information may include all information regarding the vehicle model of the traveling vehicle, and the information may include all information regarding a production year, a model year, and the number of kilometers driven of the traveling vehicle, production location of traveling vehicle parts, or the like. In Step S420, the steering device control device 300 may check a system allowable maximum compensation amount based on information about the traveling vehicle. That is, the steering device control device 300 may set the system allowable maximum compensation amount differently depending on the traveling vehicle, based on information about the traveling vehicle. Therefore, even when the traveling vehicles are of the same type, in a case where the traveling vehicles are different in terms of the number of kilometers driven or the place of production of parts, the system allowable maximum compensation amount may be different. In Step S430, the steering device control device 300 may set information provided to the traveling vehicle 100 according to the system allowable maximum compensation amount. In this case, the information provided above refers to information on whether the steering device control device 300 may perform the compensation with an actual compensation amount, perform compensation with a flag for deviation values equal to or more than the maximum compensation amount, or distinguish compensation by adding a Roll Angle.

Hereinafter, an exemplary computing device in which a steering device control device can be implemented will be described in detail using FIG. 6.

FIG. 6 is a diagram of an example computing device that may implement devices and/or systems according to various embodiments of the present disclosure.

A computing device 1500 may include one or more processors 1510, a bus 1550, a communication interface 1570, a memory 1530 that loads a computer program 1591 performed by the processor 1510, and a storage 1590 for storing a computer program 1591. However, only components related to the embodiment of the present disclosure are illustrated in FIG. 6. Accordingly, a person skilled in the art to which the present disclosure pertains can recognize that other general-purpose components may be included in addition to the components illustrated in FIG. 6.

The processor 1510 controls the overall operation of each component of the computing device 1500. The processor 1510 may include a Central Processing Unit (CPU), a Micro Processor Unit (MPU), a Micro Controller Unit (MCU), a Graphic Processing Unit (GPU), or any type of processor well known in the art of the present disclosure. Additionally, the processor 1510 may perform operations on at least one application or program to execute a method according to embodiments of the present disclosure. The computing device 1500 may include one or more processors.

The memory 1530 stores various data, commands, and/or information. The memory 1530 may load one or more programs 1591 from the storage 1590 to execute a method according to embodiments of the present disclosure. The memory 1530 may be implemented as a volatile memory such as RAM, but the technical scope of the present disclosure is not limited thereto.

The bus 1550 provides communication functionality between components of the computing device 1500. The bus 1550 may be implemented as various types of buses, such as an address bus, a data bus, and a control bus.

The communication interface 1570 supports wired and wireless Internet communication of the computing device 1500. Additionally, the communication interface 1570 may support various communication methods other than Internet communication. To this end, the communication interface 1570 may be configured to include a communication module well known in the technical field of the present disclosure.

According to some embodiments, the communication interface 1570 may be omitted.

The storage 1590 may non-temporarily store the one or more programs 1591 and various data.

The storage 1590 may include a non-volatile memory such as a Read Only Memory (ROM), an Erasable Programmable ROM (EPROM), an Electrically Erasable Programmable ROM (EEPROM), and a flash memory, a hard disk, a removable disk, or any type of computer-readable recording medium well known in the art to which the present disclosure pertains.

When the computer program 1591 is loaded into the memory 1530, the computer program 1591 may include one or more instructions that cause the processor 1510 to perform methods/operations according to various embodiments of the present disclosure. That is, the processor 1510 can perform methods/operations according to various embodiments of the present disclosure by executing the one or more instructions.

So far, various embodiments of the present disclosure and effects according to the embodiments have been mentioned with reference to FIGS. 1 to 6. The effects according to the technical idea of the present disclosure are not limited to the effects mentioned above, and other effects not mentioned may be clearly understood by those skilled in the art from the description of the specification.

The technical idea of the present disclosure described so far with reference to FIGS. 1 to 6 may be implemented as computer-readable code on a computer-readable medium. The computer-readable recording medium may be, for example, a removable recording medium (CD, DVD, Blu-ray disk, USB storage device, removable hard disk) or a fixed recording medium (ROM, RAM, computer-equipped hard disk). The computer program recorded on the computer-readable recording medium can be transmitted to another computing device through a network such as the Internet and installed on the other computing device, and thus can be used in the other computing device.

In the above, even though all the components constituting the embodiments of the present disclosure have been described as being combined or operated in combination, the technical idea of the present disclosure is not necessarily limited to these embodiments. That is, within the scope of the purpose of the present disclosure, all of the components may operate by selectively combining one or more of them.

Although operations are illustrated in the drawings in a specific order, it should not be understood that the operations must be performed in a specific or sequential order as illustrated or that all of the illustrated operations must be performed to obtain the desired results. In certain situations, multitasking and parallel processing may be advantageous. Moreover, the separation of the various components in the embodiments described above should not be construed as necessarily requiring such separation, and the program components and systems described may generally be integrated together into a single software product or packaged into multiple software products.

Although embodiments of the present disclosure have been described above with reference to the attached drawings, those skilled in the art will understand that the present disclosure can be implemented in other specific forms without changing the technical idea or essential features. Therefore, the embodiments described above should be understood in all respects as illustrative and not restrictive. The scope of protection of the present disclosure should be interpreted in accordance with the claims below, and all technical ideas within the equivalent scope should be interpreted as being included in the scope of rights of the technical ideas defined by the present disclosure.

What is claimed is:

1. A method which is performed by a steering device control device and determines a traveling stability risk factor by detecting a part of a road wheel actuator, the method comprising:
(a) transmitting a steering angle of a driver from a steering wheel actuator to a road wheel actuator;
(b) transmitting a feedback torque from the road wheel actuator to the driver based on a rack force;
determining micro-buckling of a tie-rod during the (a) and (b); and
when the micro-buckling is determined, providing the determination to a traveling vehicle system.

2. The method of claim 1, wherein the determining of the micro-buckling of the tie-rod further includes checking a wheel speed, a rack speed, and a vehicle rotation angle speed.

3. The method of claim 2, wherein the determining of the micro-buckling of the tie-rod further includes checking a rack target position, a rack position location, and the rack force.

4. The method of claim 3, wherein the determining of the micro-buckling of the tie-rod further includes setting a compensation amount in a straight-forward determination logic.

5. The method of claim 1, wherein when the micro-buckling is determined, providing of the determination to the traveling vehicle system further includes calculating information about a traveling vehicle.

6. The method of claim 5, wherein when the micro-buckling is determined, the providing of the determination to the traveling vehicle system further includes checking a system allowable maximum compensation amount based on the information about the traveling vehicle.

7. The method of claim 6, wherein when the micro-buckling is determined, the providing of the determination to the traveling vehicle system further includes setting the information provided to the traveling vehicle according to the system allowable maximum compensation amount.

8. A steering device control device comprising:
a processor;
a network interface;
a memory; and
a computer program loaded into the memory and executed by the processor,
wherein the processor includes
(a) an instruction for transmitting a steering angle of a driver from a steering wheel actuator to a road wheel actuator,
(b) an instruction for transmitting a feedback torque from the road wheel actuator to the driver based on a rack force,
an instruction for determining micro-buckling of a tie-rod during the (a) and (b) instructions, and
when the micro-buckling is determined, an instruction for providing the determination to a traveling vehicle system.

9. The steering device control device of claim 8, wherein the instruction for determining the micro-buckling of the tie-rod further includes an instruction for checking a wheel speed, a rack speed, and a vehicle rotation angle speed.

10. The steering device control device of claim 9, wherein the instruction for determining the micro-buckling of the tie-rod further includes an instruction for checking a rack target position, a rack position location, and the rack force.

11. The steering device control device of claim 10, wherein the instruction for determining the micro-buckling of the tie-rod further includes an instruction for setting a compensation amount in a straight-forward determination logic.

12. The steering device control device of claim 8, wherein when the micro-buckling is determined, an instruction for providing the determination to the traveling vehicle system further includes an instruction for calculating information about a traveling vehicle.

13. The steering device control device of claim 12, wherein when the micro-buckling is determined, the instruction for providing the determination to the traveling vehicle system further includes an instruction for checking a system allowable maximum compensation amount based on the information about the traveling vehicle.

14. The steering device control device of claim 13, wherein when the micro-buckling is determined, the instruction for providing the determination to the traveling vehicle system further includes an instruction for setting the information provided to the traveling vehicle according to the system allowable maximum compensation amount.
